(19) United States
(12) Patent Application Publication
(10) Pub. No.: US 2003/0177058 A1
(43) Pub. Date: Sep. 18, 2003

(54) Position dependent offers

(76) Inventor: Bradford Needham, North Plains, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/099,397

(22) Filed: Mar. 15, 2002

(51) Int. Cl. G06F 17/60

(52) U.S. Cl. 705/10

(57) ABSTRACT

Extending offers based on the travels of an offeree. A positioning determining device may be used to track the travels of the offeree.

### FIELD OF THE INVENTION

The invention generally relates to making offers depending on the position of an offeree, and more particularly to utilizing a position determining device, such as a Global Positioning System (GPS) to determine an offeree's position.

### BACKGROUND

Historically, mailed advertisements have been tailored to different regions receiving an offer. For example, based on various considerations, an offeror's offer to sell a particular good on the West coast may have a price and/or offer terms more advantageous than an offer made by the same offeror to offerees on the East coast. Typically an offeree's region, or position, was determined with respect to a mailing address for the offeree. However, with the advent of portable electronic devices, such devices that can be sensed as coming within range of a certain location, the traditional by-mail offer has been adapted to providing offers as such devices come into range of an offeror. For example, currently, an Institute of Electrical and Electronics Engineers (IEEE) 802.11 “hotspot” is able to sense when 802.11 devices come in range of the hotspot. Currently, systems exist where, under certain restricted circumstances, a device coming into range of a hotspot is sent an offer.

A significant limitation with the traditional mail-based offers is that they are generally blindly sent out, with little assurance that they are received by anyone who is interested in the offer. A significant limitation with the newer technique of sending electronic devices an offer as they come into range of a hotspot, is that there is a lot of merchants, and comparatively few hotspots and devices capable of receiving offers from the hotspots. Thus, in a general business context, e.g., typical shopping establishments in a city, it is unlikely that an offeror will have an offeree come into range. This unlikelihood will restrict the advancement of this sales technique. In addition, another problem is the timing of offers, e.g., it may be distracting to receive messages as one drives past a coffee shop.

### BRIEF DESCRIPTION OF THE DRAWINGS

The features and advantages of the present invention will become apparent from the following detailed description of the present invention in which:

FIG. 1 illustrates exemplary travel on a first day through a region.

FIG. 2 illustrates exemplary travel on a second day through the region.

FIG. 3 illustrates one technique, according to an embodiment of the invention, for reliably providing a tracking device to an offeree where a track log from the device can be obtained for later analysis for determining offers.

FIG. 4 illustrates a suitable computing environment in which certain aspects of the invention may be implemented.

### DETAILED DESCRIPTION

A more efficient approach is to monitor the travels of a potential offeree (hereafter simply an “offeree”) and make offers based on the offeree's travels. These offers may be dependent on various travel characteristics, such as the areas visited by the offeree, the frequency of passing certain locations, e.g., certain retail locations, entertainment locations, highways, etc. In addition, offers can be deferred in time, to avoid distracting an offeree, e.g., so as to avoid interfering with the driving of an automobile. To allow statistics to come into play when making offers, it is assumed herein that travels of an offeree is monitored over several days of travel. It will be appreciated, however, that multiple day travel is not necessary if offers are made simply because an offeree passes a certain location or business establishment.

In one embodiment, an offeree is in possession of a Global Positioning System (GPS) or equivalent device that tracks travels by way of a track log or other memory which records spatial position data which can be cross-referenced to maps or other resources to identify establishments passed by the offeree while traveling.

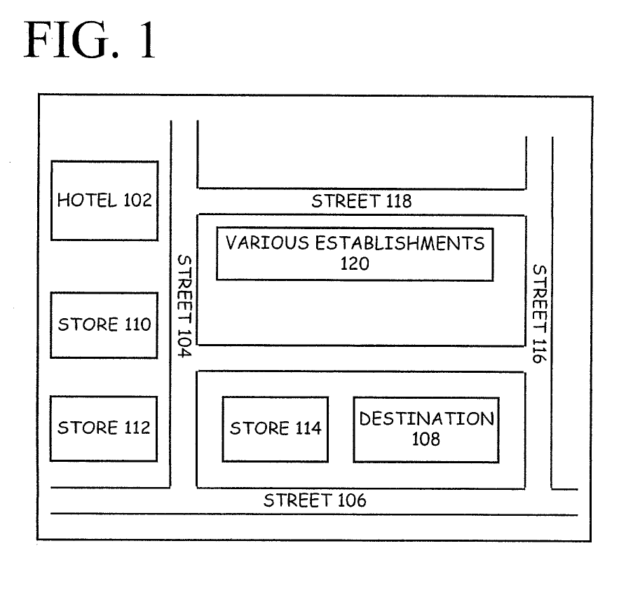

FIG. 1 illustrates exemplary travel on a first day through a region 100. While traveling, the offeree leaves a hotel 102, and drives over a first 104 and second 106 street to a destination 108, and en route passes several retail establishments (e.g., stores) 110, 112, stops at one establishment 114, and then continues on to the destination 108. On returning to the hotel, the offeree drives back to the hotel over via a different route using the second 106 street in conjunction with a third 116 and a fourth street 118, and en route, passes various establishments 120, before reaching the hotel.

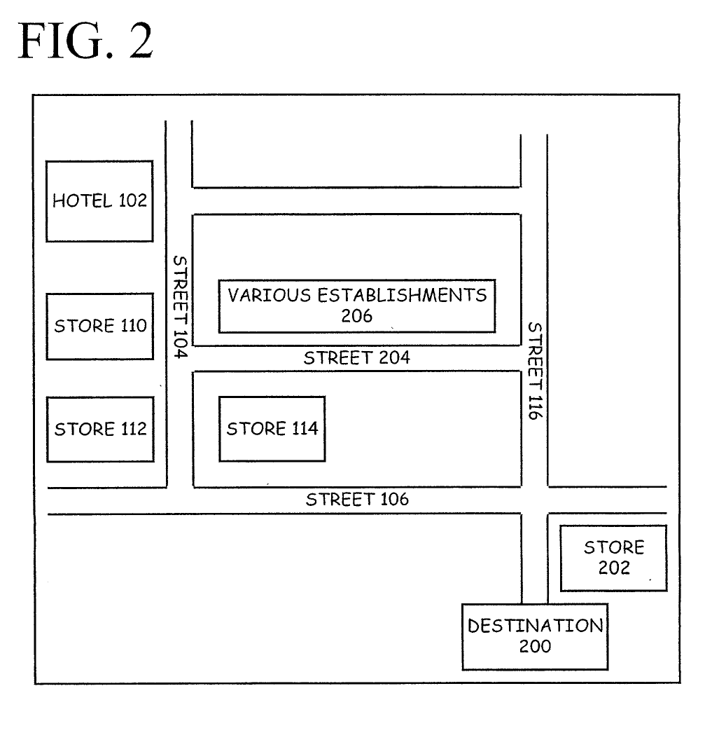

FIG. 2 illustrates exemplary travel on a second day through the region 100. While traveling, the offeree leaves the hotel 102, drives over the first 104 and second 106 streets for a different destination 200, and en route passes the retail establishments 110, 112, stops again at establishment 114, and then continues on, passing a new store 202, before arriving at the destination 200. On returning to the hotel, the offeree drives to the hotel using the third 116 street, a fifth street 204, and the first street 104. While driving, the offeree passes various establishments 206, and then passes establishment 110 again before arriving at the hotel.

It will be appreciated by one skilled in the art that these driving examples are simplistic, e.g., real travel could result in detailed data indicating various places an offeree has traveled, stopped at, lingered at, etc. Based on track log data for the illustrated FIG. 1 and FIG. 2 traveling, offers can now be extended. Although one may assume an offeree has possession of a tracking device, such as a GPS, there is a practical difficulty in reliably getting tracking devices into the possession of offerees such that track logs may be later obtained for inspection for offer analysis.

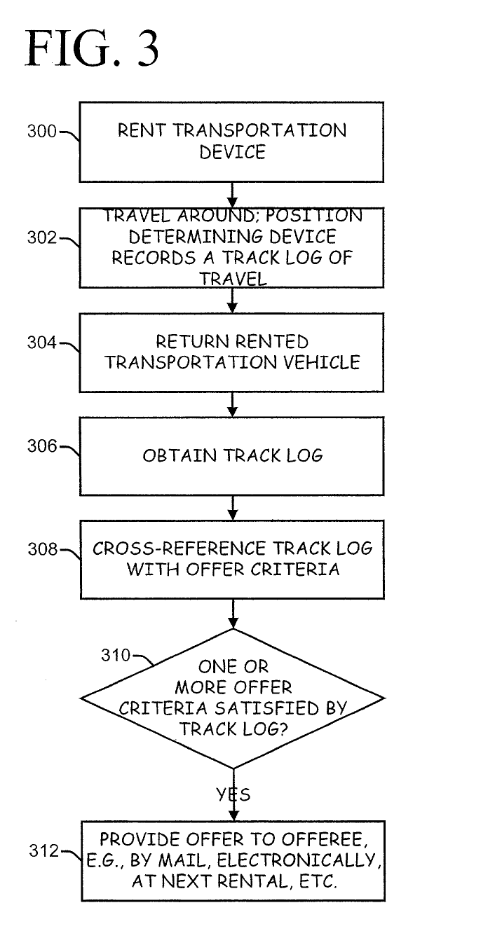

FIG. 3 illustrates one technique, according to an embodiment of the invention, for reliably providing a tracking device, e.g., a GPS, to an offeree where a track log from the device can be obtained for later analysis for determining offers. In the illustrated embodiment, the context of a rental agency is used to provide the tracking device. The rental agency rents an item that is, or that incorporates, a tracking device. It will be appreciated other methods or business relationships may be used to reliably provide position determining devices.

For example, assume the tracking device is disposed within a rented transportation vehicle, such as a rental car, truck, motorcycle, etc. A first operation is for the rental agency to rent 300 to an offeree a transportation device including a position determining device, e.g., a GPS or equivalent device, that provides a track log indicating movement of the position determining device. For example, a customer might rent a car from a Hertz car rental agency in San Diego.

After obtaining the rented transportation vehicle, the offeree travels 302 around, e.g., such as discussed above with respect to FIG. 1 and FIG. 2. Eventually the offeree returns 304 the rented transportation vehicle. The rental agency obtains 306 the track log from the rented transportation vehicle, and cross-references 308 the track log with known offers to determine if 310 an offer has offer criteria satisfied by the track log. For example, assuming the track log is a simple list of spatial coordinates identifying where the offeree traveled, and an offer is dependent on an offeree passing by a certain location, track log coordinates can be compared against coordinates for the certain location to determine if the offeree qualifies for the offer. It will be appreciated various lookups, database searches, etc. may be used to identify offer criteria for comparison.

In one embodiment, offers have an associated acceptable distance measuring the allowable distance between an offeree (determined via a track log entry) and the certain location. In this embodiment, when testing if 310 offer criteria is satisfied, if the offeree travels within the acceptable distance of the certain location, then, assuming other offer criteria, if any, is met, then the offeree qualifies for the offer. This avoids an offeree having to travel to the exact coordinates of the certain location, and also accounts for imprecise position determining devices. For dense areas, the acceptable distance may be small to allow for distinguishing between adjacent locations. Also, position data can be represented and compared in four dimensions, allowing an offer to be contingent with respect to altitude and/or time.

It will be appreciated an offer may have various requirements, such as the number of times (or frequency) an offeree passes the certain location, whether the offeree chooses to stop at the certain location, whether the offeree passes but does not stop at the certain location, etc. that are evaluated when cross-referencing 308 and checking if 310 offer criteria is satisfied. It will be further appreciated that an offer can be dependent on multiples of such requirements for multiple locations, and there may be multiple offers for varying circumstances. For example, a restaurant may have a first offer dependent on the offeree simply traveling past the first restaurant, yet also have a second, better offer, for offerees that travel past the first restaurant and stop at a competitor restaurant. State information may be stored for comparing travel against offers having complex requirements, such as statistical requirements regarding the frequency certain locations were visited over a period of time.

If 310 an offer's criteria is satisfied by cross-referencing 308 the track log with offer criteria, an offer is presented 312 to the offeree. It will be appreciated by one skilled in the art that many techniques may be applied to providing the offer. For example, in one embodiment, the offeree receives a coupon in the mail. In another embodiment, the offeree receives the offer the next time the offeree rents from the rental agency. In another embodiment, the offeree has an identification number which may be presented over a network interface, such as a web browser, allowing the offeree to enter the identification number to see if any offers are currently being presented to the offeree. In another embodiment, offers are electronically distributed to the offeree, such as through an e-mail system, instant messaging type of system, or other data delivery system.

Thus, applying FIG. 3 to the travels illustrated in FIG. 1 and FIG. 2, store 112 may have an offer with criteria indicating that if an offeree passes by store 112, issue the offeree a 5 percent off coupon; however if the offeree stops at a competitor store, e.g., store 114, then store 112 may send an offer for a 15 percent discount. Similarly, the various establishments 120 and 206 may send the offeree offers based on the single time the offeree passed their stores (in this example, only once), whereas store 110 may extend a significant offer since the offeree passed store 110 several times. It will be appreciated that any imaginable combination of criteria may be used to control offers. For example, if store 202 is a morning bakery, it may have an offer with criteria that the offeree pass store 202 during their morning business hours.

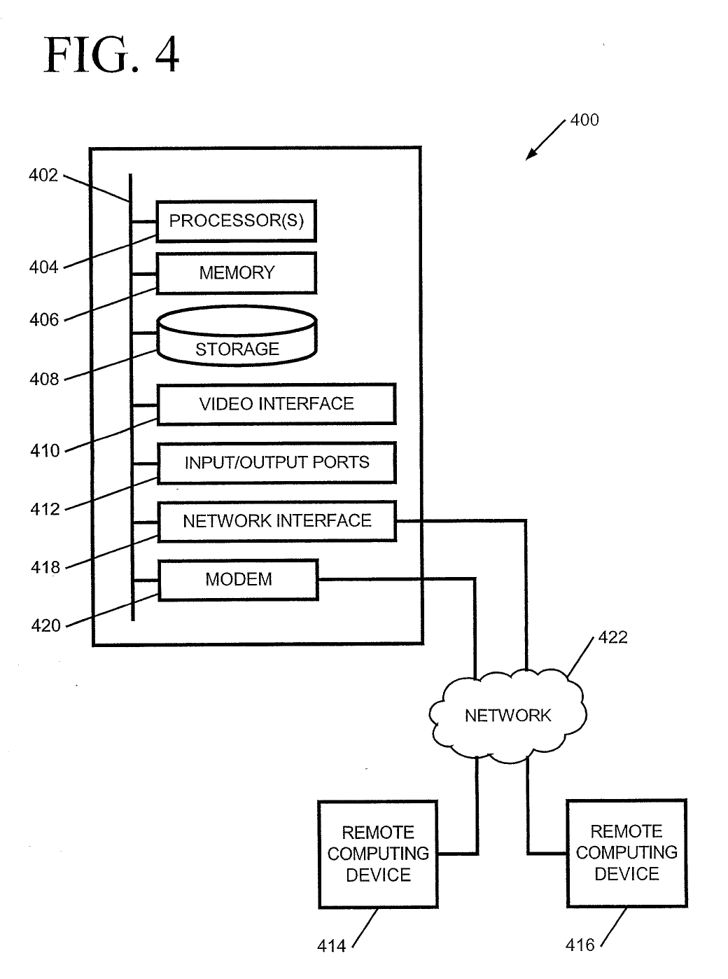

FIG. 4 and the following discussion are intended to provide a brief, general description of a suitable computing environment in which certain aspects of the illustrated invention may be implemented.

An exemplary system including, for example, the position determining device utilized in FIG. 3, includes a machine 400 having system bus 402. As used herein, the term “machine” includes a single machine, such as a computer, handheld device (e.g., a GPS), transportation vehicle, or a system of communicatively coupled machines or devices. Typically, attached to the bus are processors 404, a memory 406 (e.g., RAM, ROM), storage devices 408, a video interface 410, e.g., a monitor output port, built-in Liquid Crystal Display (LCD), or the like, and input/output interface ports 412. The machine 400 may be controlled, at least in part, by input from conventional input devices, such as keyboards, mice, joysticks, as well as directives received from another machine or biometric feedback, e.g., data incident to monitoring a person, plant, animal, organism, etc.

The machine may also include embedded controllers, such as Generic or Programmable Logic Devices or Arrays, Application Specific Integrated Circuits, single-chip computers, smart cards, or the like, and the machine is expected to operate in a networked environment using physical and/or logical connections to one or more remote machines 414, 416 through a network interface 418, modem 420, or other data pathway. Machines may be interconnected by way of a wired or wireless network 422, such as an intranet, the Internet, local area networks, wide area networks, cellular, cable, laser, satellite, microwave, “Bluetooth” type networks, optical, infrared, or other short range or long range wired or wireless carrier, as well as by way of input/output ports 412. Remote machines 414, 416 may be configured like machine 400, and therefore include many or all of the elements discussed for machine.

The invention may be described by reference to or in conjunction with program modules, including functions, procedures, data structures, application programs, etc. for performing tasks, or defining abstract data types or low-level hardware contexts. Program modules may be stored in memory 406 and/or storage devices 408 and associated storage media, e.g., hard-drives, floppy-disks, optical storage, magnetic cassettes, tapes, flash memory cards, memory sticks, digital video disks, biological storage. Program modules may be delivered over transmission environments, including network 422, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the illustrated embodiments, assuming machine 400 operates a position determining device, which may be disposed in a transportation vehicle, then remote machines 414, 416 may respectively be an offer processing server and a rental agency. In this illustrated embodiment, the offer processing server acts as a middle-man, receiving offers, such as from FIG. 1 store 112, and track log data from the rental agency. The offer processing server can then match track log entries with offers and extend offers to the offeree on behalf of participating stores. Regarding the connection between machine 400 and the remote machines, it will be appreciated that machine 400 may not have direct connection to the network 422, and instead a connection occurs indirectly by way of a rental agency (not illustrated) or other agency which is attached to the network 422, e.g., the rental agency reads track log data from the machine 400, such as though input/output ports, and provides the track log data to a remote machine.

It will be appreciated that the rental agency may perform the services of the offer processing server, thus directly issuing offers when track logs are received from return rentals. However, the illustrated embodiment allows for privacy options, such as an arrangement where the rental agency does not analyze the track logs, and the offer processing server does so without being informed of the identity of the offeree. If an anonymous identifier is associated with a track log, the offer processing server may indicate to the rental agency which offers are applicable to a particular track log identifier, and the rental agency then matches offers to offerees without knowing where the offerees traveled. For efficiency, multiple offer processing servers may be used to process track logs from multiple sources, e.g., rental agencies or other establishments providing track logs.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method, comprising:
providing to an offeree a transportation device including a positioning device that provides a track log indicating movement of the positioning device;
receiving a track log indicating travels performed by the offeree; and
cross-referencing at least a portion of the track log with known offers to determine if a first offer has offer criteria satisfied by the track log.

2. The method of claim 1, further comprising:
determining the first offer has offer criteria satisfied by the track log; and
providing the first offer to the offeree.

3. The method of claim 2, further comprising:
determining a second offer is satisfied by at least a portion of the track log; and
checking whether the second offer is related on the first offer.

4. The method of claim 1, wherein providing the transportation device comprises:
renting the transportation device to the potential offeree.

5. The method of claim 4, wherein the transportation device is an automobile.

6. The method of claim 1, further comprising:
comparing a track log entry with a hotspot associated with the offer to determine an estimated distance between the track log entry and the hotspot; and
determining whether the estimated distance is less than an acceptable distance associated with the first offer

7. The method of claim 1, further comprising:
analyzing the track log to determine the offeree stopped at a location identified by the track log.

8. The method of claim 1, further comprising:
analyzing the track log to determine the offeree passed by a location identified by the track log.

9. The method of claim 1, further comprising:
analyzing the track log to determine a count of how many times the offeree passed by a location identified by the track log.

10. The method of claim 1, further comprising:
providing at least a portion of the track log to an offer processing server; and
receiving indication from the offer processing server that the first offer is satisfied;
wherein the offer processing performs the cross-referencing the track log with known offers to determine if the first offer has offer criteria satisfied by the track log.

11. A method, comprising:
renting a positioning device that provides a track log indicating movement of the positioning device from a rental agency configured to extend offers based at least in part on a cross-reference between at least a portion of the track log with offer criteria; and
providing the track log to the rental agency.

12. The method of claim 11, wherein the rental agency is further configured to provide the at least a portion of the track log to an offer processing server configured to perform the cross-reference between the track log and offer criteria.

13. The method of claim 11, further comprising:
receiving an offer.

14. The method of claim 11, wherein the offer is received electronically.

15. The method of claim 11, wherein the offer is received via mail delivery.

16. The method of claim 11, wherein the offer is received at a subsequent rental.

17. A machine accessible medium having associated instructions, which when accessed, results in a machine performing:
facilitating providing to an offeree a transportation device including a positioning device that provides a track log indicating movement of the positioning device;
receiving a track log indicating travels performed by the offeree; and
cross-referencing at least a portion of the track log with known offers to determine if a first offer has offer criteria satisfied by the track log.

18. The medium of claim 17, the instructions comprising further instructions, when accessed, results in the machine performing:
determining the first offer has offer criteria satisfied by the track log; and
providing the first offer to the offeree.

19. The medium of claim 18, the instructions comprising further instructions, when accessed, results in the machine performing:
determining a second offer is satisfied by at least a portion of the track log; and
checking whether the second offer is related on the first offer.

20. The medium of claim 17, the instructions comprising further instructions, when accessed, results in the machine performing:
comparing a track log entry with a hotspot associated with the offer to determine an estimated distance between the track log entry and the hotspot; and
determining whether the estimated distance is less than an acceptable distance associated with the first offer.

21. The medium of claim 17, the instructions comprising further instructions, when accessed, results in the machine performing:
providing at least a portion of the track log to an offer processing server which performs the cross-referencing the track log with known offers; and
receiving indication from the offer processing server that the first offer is satisfied.
